(19) United States
(12) Patent Application Publication
(10) Pub. No.: US 2012/0228433 A1
(43) Pub. Date: Sep. 13, 2012

(54) KITE MESSENGER

(76) Inventor: Raymond Tice, Howell, MI (US)

(21) Appl. No.: 13/042,568

(22) Filed: Mar. 8, 2011

(51) Int. Cl. B64C 31/06

(52) U.S. Cl. 244/155 R

(57) ABSTRACT

A kite messenger having an elongated body with a front and rear end. At least one sail is pivotally mounted to the body at a position spaced from the rear end of the body and movable between a first position in which the sail extends outwardly from the body and a second position in which the sail folds against the body. A latch is mounted to the body adjacent its rear end and movable between an open and a closed position. In its closed position, the latch holds one end of an elongated tether while the other end of the tether is attached to the sail and holds the sail in its first position. An actuator mounted to the front of the body opens the latch when the messenger reaches a predetermined position thus allowing the sail to collapse to its second position. A pair of guides are attached to the body and slidably attach the body to a kite string.

### BACKGROUND OF THE INVENTION

I. Field of the Invention

The present invention relates to a kite messenger for transporting a load from the ground to a kite while in flight.

II. Description of Related Art

There are many previously known kite messengers. Such kite messengers transport a load from the ground to a kite while the kite is in flight. Such messengers utilize the kite string to guide the messenger from the ground and to the kite.

For example, such messengers are particularly useful in fishing for transporting bait from the fishing boat and to a kite trailing the fishing boat. By transferring the bait to a location greatly spaced from the boat reduces the possibility that noises from the boat will scare the fish away.

Even though there have been previously known messengers, the previously known messengers were only capable of transporting relatively light loads to the kite while the kite is in flight. As such, these previously known messengers have enjoyed only limited acceptance.

### SUMMARY OF THE PRESENT INVENTION

The present invention provides a kite messenger which overcomes the above-mentioned disadvantages of the previously known kite messengers.

In brief, the kite messenger of the present invention comprises an elongated body having a front end and a rear end. Preferably, the body is formed from a pair of elongated, lightweight tubes.

At least one and preferably two sails are pivotally mounted to the body at a position spaced from the rear end of the body. The sails are pivotal between a first position in which the sails extend laterally outwardly from the body, and a second position in which the sails fold against the body.

At least two guides are attached to and are longitudinally spaced along the body. These guides are adapted to slidably attach the body to a kite string. Preferably, the guides comprise rollers which roll along the kite string and are supported to the body by U-shaped roller supports. As such, the kite string is entrapped between the U-shaped roller supports and the rollers.

At least one latch is mounted to the body adjacent its rear end. The latch is movable between a closed position and an open position.

An actuator is slidably mounted to the body and has a front end which protrudes forwardly of the front end of the body. The rear end of the actuator is attached to the latch so that the latch is movable between a hold position and a release position in unison with the actuator. Actuation of the actuator from the hold and to the release position simultaneously and respectively moves the latch from its closed and to its open position.

An elongated tether has one end attached to the sail and its other end releasably held by the latch when the latch is in its closed position. Furthermore, the tether is dimensioned so that, with the other end of the tether held by the latch, the tether holds the sail in its first position in which the sail extends laterally outwardly from the messenger body.

Preferably, a second sail is also pivotally mounted to the body at a position longitudinally spaced from the first sail. A second tether extends between the first sail and the second sail and this tether is dimensioned to hold the first sail in its first or laterally outwardly extending position while the first sail is in its first or laterally outwardly extending position. Conversely, as the first sail moves to its second or collapsed position, the second tether likewise permits the second sail to move to its collapsed position.

In practice, the sails are moved to their first or laterally outwardly extending position and the second end of the tether is mounted to the latch. The body is then attached to the kite string by the guides.

Upon release of the messenger, the wind power engages the sail or sails and propels the kite messenger up the kite string and towards the kite. A stop is attached to the kite string adjacent the kite so that, when the messenger reaches the stop, the stop moves the actuator to its release position thus moving the latch to its open position and releasing the second end of the tether. Upon the release of the tether, the wind moves both sails to their second or collapsed position thus allowing the kite messenger to return to the ground due to gravity.

The latch may also be used to release a payload, such as bait from a fishing boat, once the latch is moved to its open position. Any conventional mechanism may be used to dispense the payload, if desired, once the kite messenger reaches the kite.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an environmental view illustrating the operation of the kite messenger of the present invention;

FIG. 2 is a side view illustrating a preferred embodiment of the present invention;

FIG. 3 is a fragmentary side view illustrating the operation of the actuator and latch with the latch in its closed position; and

FIG. 4 is an exploded view illustrating a portion of the present invention.

### DETAILED DESCRIPTION OF A PREFERRED EMBODIMENT OF THE PRESENT INVENTION

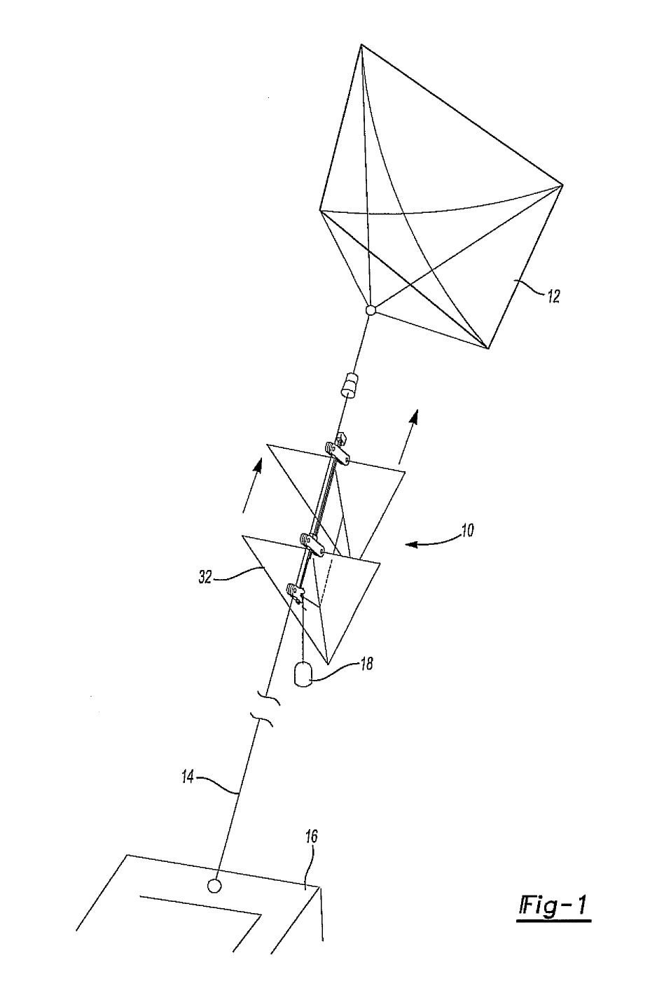

With reference first to FIG. 1, a preferred embodiment of a kite messenger 10 according to the present invention is shown for use with a kite 12 in flight. A kite string 14 tethers the kite 12 to the ground illustrated by way of example only as a boat 16.

In a fashion that will be described hereinafter in greater detail, the kite messenger 10 is used to convey a payload 18 from the ground and to a stop 20 attached to the kite string 14. The stop 20 is illustrated in FIG. 1 as adjacent the kite 12 but, in practice, may be positioned anywhere desired along the kite string 14. After the kite messenger 10 delivers the payload 18 to the stop 20, the messenger 10 returns to the ground or to the boat 16 by gravity.

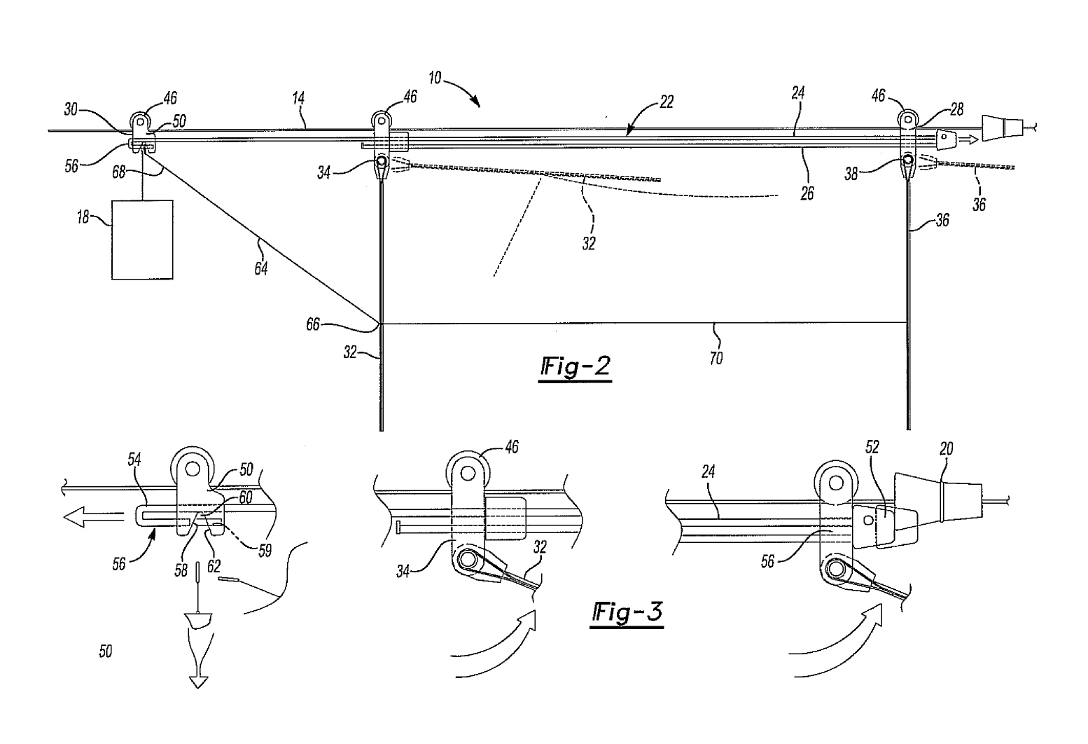

With reference now to FIGS. 2 and 3, the kite messenger 10 includes an elongated body 22 preferably constructed from a pair of elongated tubes 24 and 26. The tubes 24 and 26 are preferably constructed of a lightweight material, such as carbon fiber, and one of the tubes 24 extends entirely from a front end 28 of the body 22 and to a rear end 30 of the body 22.

A first sail 32 is pivotally mounted to the body 22 by a bracket 34 so that the sail 32 is movable between a first position in which the sail extends laterally outwardly from the body 22 as shown in solid line in FIG. 2, and a second position in which the sail 32 folds or collapses against the body 22 as shown in phantom line in FIG. 2. This sail 32, furthermore, is pivotally mounted to the body 22 at a position longitudinally spaced from the end 30 of the body 22.

Preferably a second sail 36 is pivotally mounted to the body 22 by a bracket 38 which is substantially identical to the blanket 36. Like the first sail 32, the second sail 36 is movable between a first position in which the second sail 36 extends laterally outwardly from the body 22 as shown in solid line in FIG. 2, and a second position in which the second sail 36 collapses against the body 22 as shown in phantom line in FIG. 2 and so that its plane is generally coplanar with the plane of the first sail 32 when in its second or collapsed position.

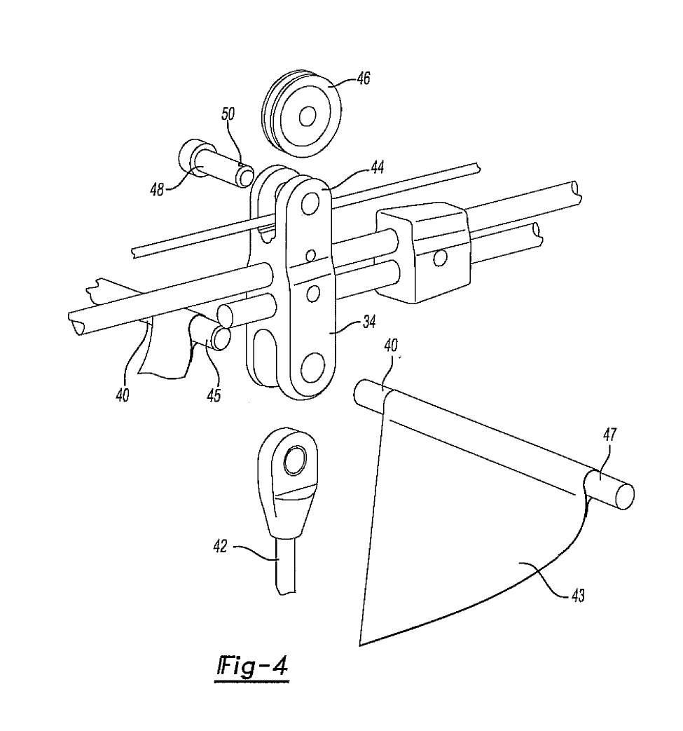

With reference to FIG. 4, the sails 32 and 36 may be constructed in any conventional fashion. However, for strong lightweight construction, the sails 32 and 36 each preferably include a pair of elongated struts 40 and 42 made of a lightweight material, such as carbon fiber. A strong flexible sheet material 43 is then secured to the struts 40 and 42 to form each of the sails 32 and 36.

In order to facilitate compact storage when not in use, the strut 40 preferably comprises two tubes 45 and 47 which are detachably secured together at the bracket 34. Thereafter the bracket 34 is slid rearwardly along the body 22 together with its associated sail. The sails 32 and 36 can then be folded inward and over each other so that the entire messenger can be rolled into a small cylindrical shape for compact storage.

With reference still to FIG. 4, each bracket 34 and 38 (only bracket 34 illustrated in FIG. 4) includes a U-shaped roller support 44. A roller or pulley 46 is rotatably mounted to the roller support 44 by an axle 48. The axle 48, however, is removably mounted in the U-shaped support 44 to allow the roller 46 to be removed when desired.

In order to attach the kite messenger 10 to the kite string 14, the axles 48 and both brackets are removed along with their corresponding rollers 46. The kite string is then positioned within the U-shaped roller supports 44 and the rollers 46 and their axles 48 are remounted on the pulley supports 44. In doing so, the kite string 14 is entrapped between the pulley 46 and the pulley support 44 thus slidably securing the messenger body 22 to the kite string 14. Any conventional means, furthermore, such as a spring-loaded ball detent 50 may be used to releasably secure each axle 48 to its associated U-shaped roller support 44. A third roller 46 is also rotatably mounted to a latch bracket 50 mounted at the rear end 30 of the body 22.

With reference now to FIG. 3, an actuator 52 is secured to and protrudes forwardly of the messenger body 22. This actuator 52 is attached to an elongated actuator tube 54 which slidably extends through the body tube 24 from the front end 28 of the body 22 and to the rear end 30 of the body 22. The actuator 52, furthermore, is movable between a hold position, illustrated in phantom line, and a release position, illustrated in solid line in FIG. 3. A spring 56, furthermore, urges the actuator 52 to its hold or forwardly protruding position.

A latch 56 is attached to the rear end of the actuator tube 54 so that the latch 56 and actuator tube 54 move in unison with each other. The latch 56 is generally U-shaped and is movable between a closed position, illustrated in phantom line in FIG. 3, and an open position, illustrated in solid line in FIG. 3. In its closed position, a free end 58 of the latch engages an opening 59 in the latch bracket 50 attached to the rear end of the body tube 22. When in its closed position, the latch 56 forms a closed eyelet 60.

Conversely, when the actuator moves to its release position, the actuator tube 54 simultaneously moves the latch 56 to its open position. In doing so, the latch 56 disengages from the bracket opening thus opening the eyelet 60 to release objects that may be contained within the eyelet. Furthermore, the latch bracket 50 preferably includes outwardly tapered walls 62 to facilitate the release of objects held within the eyelet 60.

With reference again to FIG. 2, an elongated first tether 64 has one end 66 attached to a midpoint of the sail 32 while the other end 68 of the tether 64 is retained within the eyelet 60 when the latch 56 is in a closed position. Furthermore, the tether 64 is dimensioned so that, with the end 68 entrapped in the eyelet 60 by the latch 56, the tether 64 holds the first sail 32 in its first or outwardly extending position.

A second tether 70 extends from a midpoint of the first sail 32 and to a midpoint of the second sail 36. This second tether 70 is dimensioned so that, when the first sail 32 is held in its first or outwardly extending position by the first tether 64, the second tether 70 also holds the second sail 36 in its first or outwardly extending position.

With reference now to FIGS. 1 and 2, in operation the sails 32 and 36 are moved to their first or outwardly extending position and the end 68 of the first tether 64 is attached within the eyelet 60 of the latch 56. In doing so, the first tether 64 and second tether 70 respectively retain the sails 32 and 36 in their first or outwardly extending positions. The payload 18, if any, is then attached to the body 22 in any conventional fashion, such as by attaching the payload to the latch eyelet 60.

The messenger body 22 is then attached to the kite string 14 in the previously described fashion and the messenger is released. Upon release, wind propels the messenger from the ground surface and to the stop 20 on the kite string 14. Once the messenger reaches the stop 20, the stop 20 engages the actuator 52 and moves the actuator 52 from its hold and to its release position. Simultaneously, the latch 56 is moved from its closed and to its open position. When this happens, the end 68 of the first tether 64 is released thus allowing both sails 32 and 36 to collapse to their second position. In their second position, the plane of the sails 32 and 36 is substantially parallel to the wind, rather than substantially perpendicular, thus allowing the messenger to return along the kite string 14 to the ground surface by gravity.

An important aspect of the present invention is that the entire kite messenger may be easily assembled and disassembled. This is achieved primarily since the struts 40 and 42 which form the supports for the sails 32 and 36 are detachably mounted to the body and are easily disassembled from the body. This allows the entire messenger 10 to be easily housed and transported.

Having described my invention, however, many modifications thereto will become apparent to those skilled in the art to which it pertains without deviation from the spirit of the invention as defined by the scope of the appended claims.

I claim:

1. A kite messenger for use with a kite tethered on a kite string comprising:
an elongated body having a front end and a rear end,
at least one sail pivotally mounted to said body at a position spaced from said rear end of said body and movable between a first position in which said sail extends laterally outwardly from said body and a second position in which said sail folds against said body,
a pair of guides attached to and longitudinally spaced along said body, said guides adapted to slidably attach said body to the kite string,
at least one latch mounted to said body adjacent said rear end, said at least one latch movable between a closed and an open position,
an actuator slidably movably mounted to said body and protruding forwardly of said front end of said body, said actuator attached to said latch and movable between a hold position and a release position to simultaneously respectively move said latch between said closed and said open position,
an elongated tether having one end attached to said at least one sail and its other end releasably held by said latch when said latch is in said closed position, said tether dimensioned to hold said at least one sail in said first position when said other end of said tether is held by said latch.

2. The kite messenger as defined in claim 1 wherein said at least one sail comprises a first and a second sail longitudinally spaced along said body, and a second tether extending between said first and second sails, said second tether dimensioned to hold said second sail in said first position when said first sail is in said first position.

3. The kite messenger as defined in claim 1 wherein said actuator is slidably mounted within said body and extends from a position forwardly of said body and to said latch.

4. The kite messenger as defined in claim 1 and comprising a spring which urges said actuator toward said hold position.

5. The kite messenger as defined in claim 1 wherein said latch comprises a hook having a free end, said free end of said hook positioned within a receiving hole in said body when said latch is in said closed position.

6. The kite messenger as defined in claim 1 wherein said body comprises an elongated tube.

7. The kite messenger as defined in claim 1 wherein said guides each comprise a roller detachably mounted to a U-shaped roller support so that the kite string is entrapped between said roller and said U-shaped roller support.
